(19) United States
(12) Patent Application Publication
(10) Pub. No.: US 2010/0042831 A1
(43) Pub. Date: Feb. 18, 2010

(54) Method and System for Secure Transmission of Data in an Ad Hoc Network

(76) Inventors: Michael Bahr, Munchen (DE); Michael Finkenzeller, Munchen (DE); Matthias Kutschenreuter, Munchen (DE); Christian Schwingenschlögl, Putzbrunn (DE); Norbert Vicari, Munchen (DE)

Correspondence Address: STAAS & HALSEY LLP, SUITE 700, 1201 NEW YORK AVENUE, N.W., WASHINGTON, DC, 20005, US

(21) Appl. No.: 11/922,094

(22) PCT Filed: May 5, 2006
(86) PCT No.: PCT/EP2006/062096

§ 371 Date: Nov. 2, 2009

(30) Foreign Application Priority Data
Jun. 13, 2005 (DE) 10 2005 027 232.0

(51) Int. Cl. H04L 29/00; H04L 9/08

(52) U.S. Cl. 713/160; 380/45

(57) ABSTRACT

Using at least one network consisting of at least one node, a multi-hop communication system is formed in which data are received and forwarded from a transmitting first node to a second node receiving the data via at least one third node interposed between the first and the second node. For transmission, the data are subdivided into packets that have a useful data portion (payload) and at least one first control data portion associated with the multi-hop method and a second control data portion associated with the network. The data are encrypted using a first public key determined by the first node and the second node, but only the useful data portion is encrypted using the first public key.

### CROSS REFERENCE TO RELATED APPLICATIONS

This application is based on and hereby claims priority to German Application No. 10 2005 027 232.0 filed on Jun. 13, 2005, the contents of which are hereby incorporated by reference.

### BACKGROUND

In radio communication systems, messages, containing, for example, voice information, image information, video information, SMS (Short Message Service), MMS (Multimedia Messaging Service) or other data, are transmitted between the transmitting and receiving radio station, using electromagnetic waves, via an air interface. Here the radio stations, also called nodes in network terminology, can, depending on the actual arrangement of the radio communication system, be different types of subscriber radio stations or network side radio stations such as radio access points or base stations. In a mobile communications system at least part of the subscriber radio stations are mobile radio stations. The electromagnetic waves are emitted using carrier frequencies that are in the frequency band provided for the respective system.

Mobile communications systems are often designed as cellular systems e.g. according to the GSM standard (Global System for Mobile Communication) or UMTS (Universal Mobile Telecommunications System) with a network infrastructure consisting, for example, of base stations, devices to control and direct the base stations and other network side devices.

Apart from these radio networks that are organized over a wide area (supralocal), cellular and hierarchical, there are also wireless local networks (WLANs, Wireless Local Area Networks) generally with a much more limited area of radio coverage. The cells covered by the radio access points (AP: Access Point) of the WLANs are with diameters of, for example, a few hundred meters, small in comparison with the usual mobile cells. Examples of different standards for WLANs are HiperLAN, DECT, IEEE 802.11, Bluetooth and WATM.

The unlicensed frequency range around 2.4 GHz is often used for WLANs. In the 5 GHz range there is also an international but not uniformly regulated frequency band that is often used by WLANs. With known WLANs data transmission rates of more than 50 Mbit/s can be achieved, with future WLAN standards (e.g. IEEE 802.11n) data transmission rates of more than 100 Mbit/s can be achieved. Thus data rates are available to the subscribers of the WLANs, which rates are considerably higher than those that are offered by the third generation of mobile communications, such as, for example, UMTS. Hence for the transmission of large amounts of data, in particular in connection with Internet accesses, for high bit rate connections it is of advantage to have access to WLANs.

It is also possible to connect to other communication systems, for example to the Internet, via the WLAN radio access points. To this end, the radio stations of the WLAN communicate either directly with a radio access point or in the case of more remote radio stations via other radio stations, which forward the information between the radio station and the radio access point via a path between the radio station and the radio access point. In such communication systems, known as multi-hop communication systems, a sending station transmits data either directly or via a multiplicity of interconnected intermediate or radio relay stations finally to a receiving station. In addition to the transmission of data via a single interconnected radio relay station, the data can also be transmitted via a multiplicity of radio relay stations connected in series, which is also known as multi-hop.

For non multi-hop WLAN systems it is known to use security mechanisms designed to prevent the data being transmitted from being eavesdropped on. To this end, for example, IEEE802.11i uses different keys for each logical connection, as can be seen in FIG. 1. However, this method has the disadvantage that it is only optimized for one hop but not for a multi-hop system.

There are variations of this designed to remove this disadvantage. There is for example a method whereby a so-called “pre shared key” (PSK) is used. Thereby a key is formed that is valid for the entire network, and which is used for authentication and key agreement. However, this entails a lowering of the level of security.

Thus for future standards the use of a different key for each connection is being considered. This, however, puts a strain on the system as encryption and decryption are carried out in each node, and this delays the transmission of the data and hence is an impediment to applications with a real-time requirement, such as Voice over IP.

### SUMMARY

The task is to present a method for secure communication via radio in a multi-hop system, which method avoids the disadvantage mentioned.

In the method described below for the transmission of data in a multi-hop communication system which includes at least one network consisting of at least one node, data is received and forwarded by a transmitting first node to a second node receiving the data via at least one third node interposed between the first and the second node, whereby, for transmission, the data is subdivided into packets that have a payload data portion and at least one first control data portion associated with the multi-hop method and a second control data portion associated with the network, and whereby the data is encrypted using at least one first master key determined by the first node and the second node, only the payload data portion is encrypted using the first public key.

The method described below advantageously results in an end-to-end encryption of the payload data. This means that the user data remains encrypted and hence protected until it reaches the target node. In addition, however, the pressure on the intermediate nodes is also relieved, as they do not need to decrypt the payload data, as is the case in the methods known from related art. They only forward in accordance with the information held in the control data portions. This avoids to the greatest extent possible any delays that would occur as a result of encryptions and decryptions.

If a second master key is formed determined by the respective transmitting first node and an adjacent node that is suitable as a third node and preferably the first control data portions are encrypted using the second master key, then the information associated with the multi-hop method, which information as a rule contains the path provided for the packets, and likewise cannot be analyzed; which again markedly increases the security of the system. As, in addition, the key is based on a master key that is created by the sending node and the adjacent node, only the adjacent node is capable of decoding and analyzing the control data portion and, in accordance with the information contained therein, of initiating, if necessary, forwarding to a next adjacent node.

A further improvement of the encryption and hence of the security can be achieved if a second key derived from the first master key is determined and also a first key derived from the second master key is determined, the packets for transmission in the respective first node are respectively encrypted in such a way that the first control data portion is encrypted using the first key, the payload data portion is encrypted using the second key, the second control data portion remains unencrypted and the packets are then transmitted to the third node, the third node decrypts the first control data portion encrypted using the first key and analyses the control data portion. In the case that the third node is equivalent to the second node, the payload data is subsequently decrypted using the second key and the transmission ended and in the case that the third node is not equivalent to the second node, the third node is set as the first node and the steps are repeated starting with the derivation of a first key—it is not necessary to regenerate the second key, as according to the method only an end-to-end, i.e. source node to sink, encryption of the payload data is required. The improvement in security derives from the fact that when the keys are derived, it is possible to take additional encoding measures that could make it difficult for a hacker or eavesdropper to decrypt the data or prevent them from so doing, such as the generation of the second key using a random generator, so that as a rule non-repeating keys are formed in any additional transmission.

If, in addition, packets generated according to the multi-hop method and only containing routing information are completely encrypted, then as a rule, the data exchanged for negotiating a path prior to the actual transmission of the payload data cannot be analyzed by a hacker, so that a concentration of hacker attacks on the intermediate node to be used for the transmission is not possible. Thus a further level of security is established, which in addition does not result in any delay to the payload data transmission.

Preferably, thereby the routing packets are generated in accordance with a routing protocol, so as to ensure a standardized communication between the nodes or networks.

Thereby the routing message packets can be generated within the second layer 2 of the OSI (Open Systems Interconnection) reference model or within the third layer of the OSI reference model, as these are especially suitable for implementing the method.

Preferably, especially when generation is carried out within the third layer, an AODV (Ad-Hoc On-Demand Distance Vector) protocol, OLSR (Optimized Link State Routing) protocol or derivatives of these will act as protocols.

If encryption is performed in compliance with the security procedures according to IEEE802.1X, then we have as the basis a security model that is widespread among today's networks, so that the method is more easily implemented and its acceptance is increased. This applies in particular if at least one of the networks functions according to IEEE802.11 or its derivatives.

Preferably, the second control data portion is formed by header data according to IEEE802.11 and the first control data portion by header data according to the multi-hop method, as this matches the usual procedure and thus a communication system so designed and the networks it contains can implement the method without any great adjustment.

This results in an efficient method for data encryption if encryption is performed by using a 128 bit long key in accordance with the Counter Mode CBC MAC (Cipher Block Chaining-Message Authentication Code) protocol “CCMP”.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a communication sequence diagram for a key agreement in a one-hop system according to IEEE802.1X,

FIG. 2 is a data structure diagram of a payload data packet in a communication system,

FIG. 3 schematic data structure diagram of a key hierarchy as forms the basis of the embodiment described below.

FIG. 4 is a communication sequence diagram for an embodiment described below.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

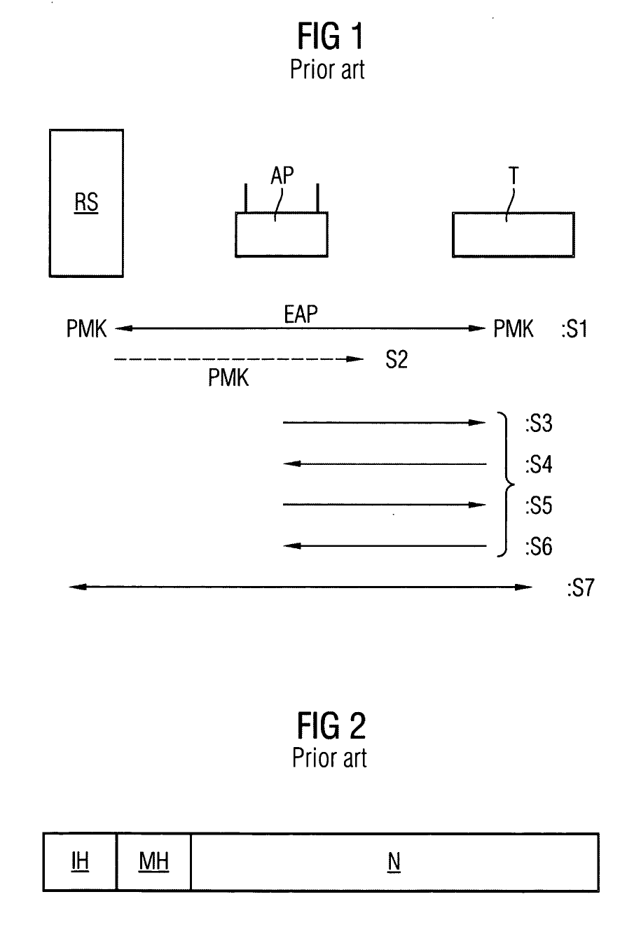

FIG. 1 represents schematically a key agreement according to IEEE802.11i, in a network standardized according to IEEE802.1X.

Hereby can be seen that it is a system limited to single hops, as the hop is reduced to one intermediate station, namely the shown Access Point AP, which serves to bridge a subscriber terminal T and a so-called Radius Server RS or to establish a wireless data transmission between the Radius Server RS and the subscriber terminal (Terminal) T.

In addition can be seen that in a first step S1 using the so-called “Extensible Authentication Protocol” EAP an authentication takes place over the shown network arranged according to IEE802.1X, which serves to agree a shared key, which is called a “Pairwise Master Key” (PMK) or in short master key.

In a second step S2, the agreed master key PMK is now conveyed to the Access Point AP, so that in the subsequent steps S3 to S6 the Access Point AP, in a so-called handshake (exchange of information) generates a necessary key for a transmission session for the communication between Terminal T and Access Point AP.

To this end, in the third step S3 a random sequence is generated in Access Point AP and transmitted to the Terminal T, which, in the fourth step S4, likewise generates a random sequence and using the random sequence of Access Point AP transmits this in encrypted form to Access Point AP, so that in the fifth step S5, in conjunction with the master key, a valid key, designated the group key, can be generated in Access Point AP for the connection between Access Point AP and Terminal T and conveyed encrypted to Terminal T with its random sequence and Terminal T and Access Point AP both have the information available that enables a so-called “Pairwise Transient Key” (PTK) to be generated, which PTK is valid for the duration of the session.

The successful conclusion of this generation culminates in its acknowledgement in the sixth step S6 with a confirmation message encrypted with the PTK sent to the Access Point AP.

In a seventh step S7, the data transmission between Radius Server RS and Terminal T, which is now secured by encryption, can now take place.

For the transmission according to an embodiment, which is based on a network arranged according to IEEE802.11, the data is divided into packets, like the one represented in FIG. 2, which has a payload data portion N, and at least one first control data portion MH, which is necessary to effect the multi-hop method, and a second control data portion IH, which is formed in accordance with IEEE802.11.

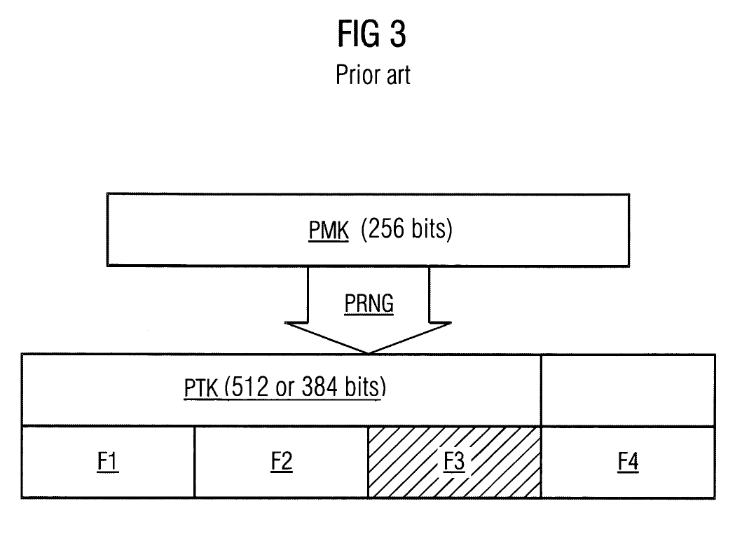

Further, in FIG. 3 there is a schematic representation of the security hierarchy on which the embodiment is based. As shown, data encryption starts from the first level EI, which is characterized by a master key (Pairwise Master Key—PMK), from which by a subsequent generation of random numbers (Pseudo Random Number Generator)—PNRG) in the second level E2 results a group key (Pairwise Transient Key—PTK), which can be 512 bits long according to TKIP or 384 bits long according to AES-CCMP, from which as can be seen in the fourth level E4, one part of which is used respectively for the encryption of specific types of data, e.g. 128 bits for EAPol Encryption FI, 128 bits for EAPol MIC F2 and 128 bits for Data Encryption F3.

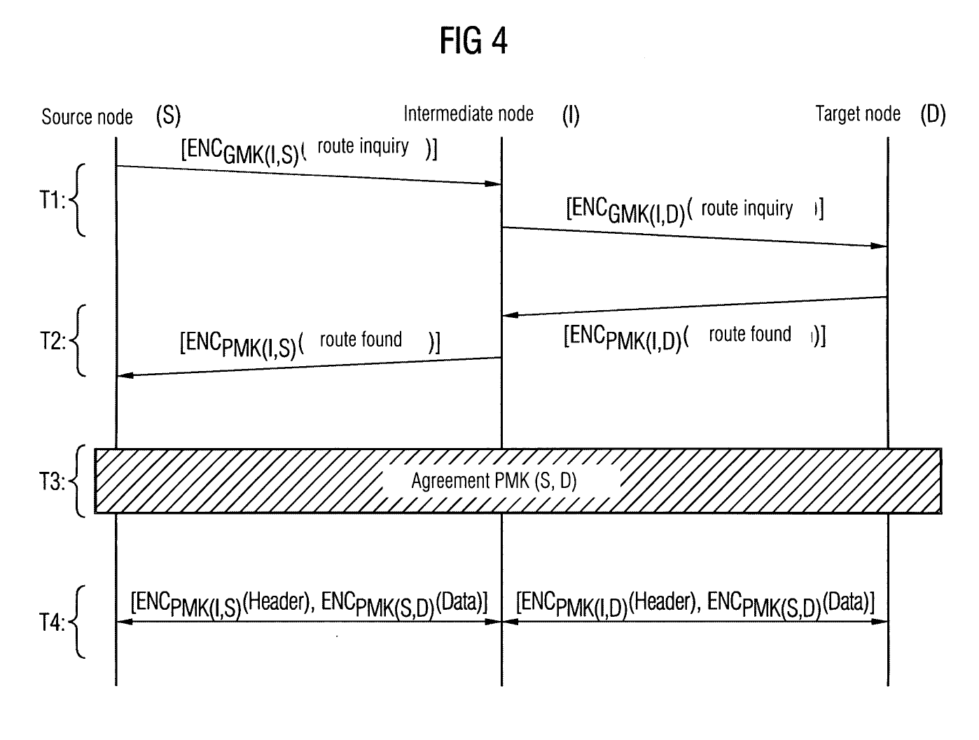

Finally FIG. 4 shows a flow chart produced on the basis of the method using the above mentioned system.

It can be seen that at a first point in time T1 a connection set up to a target node D is initiated from a source node S. Thereby in the embodiment a reactive routing protocol such as, for example AODV, is assumed, implicitly and without limiting general application.

The connection set up starts with a Route Request message being broadcast to find a suitable adjacent node to forward to D. The message is forwarded by the intermediate node I to the target node D. Keys derived from the master key GMK available for group communication are used to encrypt these messages.

Subsequent to that, at a second point in time T2, target node D reports back to the source node S that a route was found. Node D sends this message directly to node I node I forwards the message directly to node S. Thereby the route found is switched to active and can then be used for data traffic.

The encryption of the messages at the point in time T2 is implemented as follows: the message from node D to node I is encrypted using a key derived from the master key PMK (I, D) to be used for the communication between D and I. The message forwarded from node I to node S is encrypted using a key derived from the master key PMK (I, S) to be used for the communication between I and S.

At a third point in time T3, it is then possible to have a secure data connection between the source node S and target node D via which, with the mechanisms described in IEEE 802.11i and with the aid of an AAA server accessible from the multi-hop network, a master key PMK (S, D) is agreed between source node S and target node D. A common example that is used in IEEE 802.IIi for the agreement of master keys is a radius server and communication over EAP, 802.1x. This master key PMK (S, D) to be used for communication between S and D, is used at a fourth point in time T4 as follows:

Data packets for transmitting between source node S and target node D include, among other things, header information which must be used by each forwarding node (in the example node I) for the targeted forwarding of the data in a multi-hop network. The data portion of the data packets must first be able to be read again in the target node D. For that reason, the header information for the transmission from S to I is encrypted using a key derived from the key PMK (S, I), decrypted in intermediate node I and encrypted using a key derived from key PMK (I, D) for forwarding to target node D. The data portion of the data packet is encrypted in source node S using the key derived from the master key PMK (S, D) agreed at the third point in time T3 between S and D. Thus for the forwarding of the data packet from node I to target node D there is no need for cryptographic operations on the data portion of the data packet in node I. The data portion can be forwarded transparently and without changes to the target node D, where it is decrypted using a key derived from the master key PMK (S, D).

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-15. (canceled)

16. A method for the transmission of data in a multi-hop communication system forwarded by at least one network having at least one node, in which the data is received and forwarded by a transmitting first node to a second node via at least one third node interposed between the first and second nodes, comprising:
subdividing the data for transmission into packets that have a payload data portion and at least one first control data portion associated with the multi-hop method and a second control data portion associated with the network; and
encrypting the data using at least one first master key determined by the first node and the second node, with only the payload data portion encrypted using the first master key.

17. The method according to claim 16, further comprising determining a second master key by the transmitting first node and an adjacent node used as one of the at least one third node.

18. The method according to claim 17, further comprising encrypting the first control data portion using the second master key.

19. The method according to claim 18, further comprising:
deriving a first key from the second master key;
deriving a second key from the first master key;
encrypting the packets for the transmission in the transmitting first node with the first control data portion encrypted using the first key, the payload data portion encrypted using the second key, and the second control data portion remaining unencrypted;
transmitting the packets to the at least one third node;
decrypting at the at least one third node the first control data portion encrypted using the first key;
reading the control data portion at the at least one third node, deriving a new first key for another node adjacent the at least one third node and repeating said encrypting and transmitting of the packets at the at least one third node and decrypting of the first control data portion at the other node, until the other node is the second node; and
decrypting the payload data using the second key at the second node.

20. The method according to claim 19, wherein routing message packets containing only routing messages are encrypted completely.

21. The method according to claim 20, wherein the routing message packets are generated according to a routing protocol.

22. The method according to claim 21, wherein the routing message packets are generated within a second layer of an Open Systems Interconnection reference model.

23. The method according to claim 20, wherein the routing message packets are generated within a third layer of the Open Systems Interconnection reference model.

24. The method according to claim 20, using at least one of an Ad-Hoc On-Demand Distance Vector protocol, an Optimized Link State Routing protocol and a derivative of either.

25. The method according to claim 19, wherein said encrypting is carried out in compliance with security procedures according to at least one of IEEE802.1X and IEEE802.11i.

26. The method according to claim 25, wherein at least one of the networks functions in accordance with IEEE802.11 or a derivative thereof.

27. The method according to claim 26, wherein the second control data portion is formed by header data in accordance with IEEE802.11.

28. The method according to claim 27, wherein the first control data portion is formed by header data in accordance with a multi-hop transmission protocol.

29. The method according to claim 28, wherein said encrypting uses a 128 bit long key in accordance with the Counter Mode Cipher Block Chaining-Message Authentication Code Protocol.

30. The method according to claim 18, wherein routing message packets containing only routing messages are encrypted completely.

31. The method according to claim 30, wherein the routing message packets are generated according to a routing protocol.

32. The method according to claim 31, wherein the routing message packets are generated within a second layer of an Open Systems Interconnection reference model.

33. The method according to claim 30, wherein the routing message packets are generated within a third layer of the Open Systems Interconnection reference model.

34. The method according to claim 30, using at least one of an Ad-Hoc On-Demand Distance Vector protocol, an Optimized Link State Routing protocol and a derivative of either.

35. The method according to claim 17, wherein routing message packets containing only routing messages are encrypted completely.

36. The method according to claim 35, wherein the routing message packets are generated according to a routing protocol.

37. The method according to claim 35, wherein the routing message packets are generated within a second layer of an Open Systems Interconnection reference model.

38. The method according to claim 35, wherein the routing message packets are generated within a third layer of the Open Systems Interconnection reference model.

39. The method according to claim 35, using at least one of an Ad-Hoc On-Demand Distance Vector protocol, an Optimized Link State Routing protocol and a derivative of either.

40. The method according to claim 16, wherein routing message packets containing only routing messages are encrypted completely.

41. The method according to claim 40, wherein the routing message packets are generated according to a routing protocol.

42. The method according to claim 41, wherein the routing message packets are generated within a second layer of an Open Systems Interconnection reference model.

43. The method according to claim 40, wherein the routing message packets are generated within a third layer of the Open Systems Interconnection reference model.

44. The method according to claim 40, using at least one of an Ad-Hoc On-Demand Distance Vector protocol, an Optimized Link State Routing protocol and a derivative of either.

45. The method according to claim 16, wherein said encrypting is carried out in compliance with security procedures according to at least one of IEEE802.1X and IEEE802.11i.

46. The method according to claim 45, wherein at least one of the networks functions in accordance with IEEE802.11 or a derivative thereof.

47. The method according to claim 46, wherein the second control data portion is formed by header data in accordance with IEEE802.11.

48. The method according to claim 47, wherein the first control data portion is formed by header data in accordance with a multi-hop transmission protocol.

49. The method according to claim 48, wherein said encrypting uses a 128 bit long key in accordance with the Counter Mode Cipher Block Chaining-Message Authentication Code Protocol.

50. A system for transmitting data in a multi-hop method, comprising:
means for subdividing the data for transmission into packets that have a payload data portion and at least one first control data portion associated with the multi-hop method and a second control data portion associated with the network; and
means for encrypting the data using at least one first master key determined by the first node and the second node, with only the payload data portion encrypted using the first master key.
